(19) United States
(12) Patent Application Publication
(10) Pub. No.: US 2009/0223111 A1
(43) Pub. Date: Sep. 10, 2009

(54) BRISTLE STONE™ AQUARIUM WORM TRAP

(76) Inventors: Loren Fanony, Puyallup, WA (US); Mack Horne, III, Spanaway, WA (US)

Correspondence Address: DONALD W. MEEKER, 924 EAST OCEAN FRONT, # E, NEWPORT BEACH, CA, 92661, US

(21) Appl. No.: 12/466,286

(22) Filed: May 14, 2009

Related U.S. Application Data
(63) Continuation-in-part of application No. 11/897,490, filed on Aug. 30, 2007.

(51) Int. Cl. A01M 23/02

(52) U.S. Cl. 43/60

(57) ABSTRACT

A bristle worm trapping device is made from or concealed within a live rock or artificial rock. The trapping device may be made by cutting a live rock into two halves, drilling a bristle worm trap chamber within the two halves, and drilling chamber access tunnel holes in the live rock. Alternately the trapping device may be made by simply drilling a cylindrical opening in the live rock partially through or completely through the live rock forming a bristle worm trap chamber and means for accessing the chamber. Worm bait is placed within a tubular bristle worm trap having a series of worm holes. Small hungry bristle worms after entering the worm holes and eating the bait rest in the bristle worm rock and are trapped.

### CROSS-REFERENCE TO RELATED APPLICATIONS

The present utility patent application is a continuation-in-part of utility patent application Ser. No. 11/897,490 filed Aug. 30, 2007.

### STATEMENT REGARDING FEDERALLY SPONSORED RESEARCH OR DEVELOPMENT

Not Applicable.

### The Names of the Parties to a Joint Research or Development

Not Applicable.

### BACKGROUND OF THE INVENTION

1. Field of the Invention

The present invention relates to traps and to saltwater aquariums and the maintenance thereof and particularly to a Bristle Stone™ worm trap device which is made from or concealed within a stone or rock, which may be a live rock, thereby providing a more attractive trap which simulates the bristle worm's natural home; the trap device is made by either cutting a live rock in two, drilling a bait-holding cavity within the rock, and drilling bait access holes in the rock, or by simply drilling a cylindrical opening in the live rock, the bait is then placed within the cavity or cylindrical opening; alternately a plastic or PVC bait-holding pipe having end caps and sidewalls with bait access holes therein may be placed inside the cavity or cylindrical opening drilled in the rock.

2. Description of Related Art Including Information Disclosed Under 37 CFR 1.97 and 1.98

A salt water aquarium tank typically includes coral and live rocks which form a simulated reef. Live rocks include living organisms. A live rock sustains a variety of living organisms such as crustaceans, worms, clams, algae, sponges, and bacteria. At times, destructive bristle worms are inadvertently introduced into the aquarium. The bristle worms are highly prolific and can kill corals and eat clams, fish and other reef inhabitants. They need to be removed from the tank in order to preserve the condition of the simulated reef.

Prior art devices trap worms however; they are not concealed in a live rock and can detract from the appearance of the salt water aquarium.

Two U.S. Pat. No. 5,568,790 issued Oct. 29, 1996 and 5,297,513 issued Mar. 29, 1994 to Musgrave, show a worm trap for use in an aquarium for trapping worms. The worm trap includes a tube assembly having a pair of openings at the ends of the assembly. A chamber is located within the assembly and is adapted to contain a food morsel. At least one end wall of the chamber communicates with the interior of the tube assembly to allow the aroma of the food morsel to enter the tube assembly so that a worm will be attracted to the aroma and be trapped in the tube assembly. The opening in the chamber is sufficiently small to prevent the food morsel from being carried out of the tube assembly by the worm.

U.S. Pat. No. 6,874,274 issued Apr. 5, 2005 to Townsend, provides a tamper-resistant pest trap that has an outer housing that simulates a rock typically found in a garden or landscape area around a residence or building. The outer housing includes a substantially flat bottom member and a pivotally attached upper dome-shaped lid member. When the lid member is closed over the bottom member, a large cavity is formed inside the trap. Formed on the bottom member are two, inward extending tunnel cavities that form two partially concealed tunnels that extend under the trap when the trap is placed on the ground. Formed on the perimeter edge of the outer housing is an outer pest opening. From on the bottom member directly over the tunnel cavity is an inner pest opening that allows a rodent to enter the large cavity after traveling through the tunnel. Formed inside the outer housing is a holding tray designed to hold a rodentocide or a mechanical trap capable of killing the rodent. An optional bait paper tray is also formed in the bottom member to hold bait paper. An optional lock is provided to prevent tampering and stake and hold-down chain are provided to attach the trays to the ground.

What is needed is a bristle worm trap which is made from or concealed within a live rock or simulated live rock with an interior bristle worm trap chamber and chamber access tunnels leading to the interior bristle worm trap chamber for trapping bristle worms in a salt water aquarium, thereby providing a more attractive trap which simulates the bristle worm's natural home.

### BRIEF SUMMARY OF THE INVENTION

An object of the present invention is to provide a Bristle Stone™ trap which is made from or concealed within a rock or live rock, which may be a live rock, with an interior bristle worm trap chamber holding bristle worm bait in the bristle worm trap with chamber access tunnels leading to the interior bristle worm trap chamber for trapping bristle worms in a salt water aquarium, thereby providing a more attractive trap which simulates the bristle worm's natural home.

One more object of the present invention is to prevent the bristle worms' destruction of coral or simulated reef bank or other inhabitants in the aquarium by removing the bristle worms from the aquarium.

In brief, a Bristle Stone™ bristle worm trapping device which is made from or concealed within a rock or live rock, thereby providing a more attractive trap which simulates the bristle worm's natural home. The trapping device is made by either cutting a live rock in two and drilling an internal bristle trap chamber within the split live rock, or drilling a bristle worm trap chamber and chamber access tunnel into the live rock or drilling a bristle worm trap chamber and access tunnel completely through the live rock for insertion of a bristle worm trap in the bristle worm trap chamber, and drilling chamber access tunnel holes in the live rock. The bristle worm bait is then placed in a tubular bristle worm trap removably inserted within the bristle trap chamber.

A plurality of spaced bristle worm openings along the length of the bristle bait holding tube of the tubular bristle worm trap admit the hungry small bristle worms therethrough to feed on the bristle worm bait. After eating, the bristle worm stays in one of the openings in the living stone or in the tubular bristle worm trap or the worm trap chamber, so that they are removed from the tank with the Bristle Stone™ trap.

The purpose of the device is to remove bristle worms from a salt water aquarium to prevent the bristle worms from damaging coral in the salt water aquarium and from eating other inhabitants in the aquarium.

An advantage of the present invention is that it prevents the damage or destruction of coral in the aquarium.

One more advantage of the present invention is that it is an attractive, natural addition to the aquarium.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the split Bristle Stone™ worm trapping device of the present invention;

FIG. 2 is a perspective view of the split Bristle Stone™ worm trapping device of FIG. 1 showing the device split in half for access to the bristle worm trap bait holding tube in the inner bristle worm trap chamber;

FIG. 3 is a perspective view of an alternate embodiment of the Bristle Stone™ worm trapping device having a large diameter hole drilled into the stone to create the bristle worm trap chamber and passageway showing the bristle worm trap bait holding tube in the bristle worm trap chamber and passageway (dashed lines);

FIG. 4 is a perspective view of the split Bristle Stone™ worm trapping device of FIG. 1 showing one the devices at the bottom of the salt water aquarium and another of the devices being held by a mesh scoop for either installing the device in the salt water aquarium to attract bristle worms or removing the device from the salt water aquarium to remove the bristle worms in the device;

FIG. 5. is a perspective view of an alternate embodiment of the Bristle Stone™ worm trapping device having a narrow tunnel drilled through a live rock from an opening on one side to an opening on an opposite side to create a small diameter bristle worm trap chamber and passage open at each end and showing the small diameter bristle worm trap bait tube which fits in the full length of the bristle worm trap chamber and passage from one opening to the other and a bait tube plug at each end of the bait tube, each bait tube plug having a pronged tip for insertion into an end of the bait tube with a tight tension fit and an outer stone engaging ring for retaining the bait tube within the live rock and sealing the end of the bait tube holding passageway, an outwardly protruding grip for inserting and removing the bait tube plug, and a series of spaced worm openings along the length of the bait tube to allow the bristle worms to enter the bait tube;

FIG. 6 is a perspective view of the alternate embodiment of the Bristle Stone™ worm trapping device of FIG. 5 showing the bristle worm trap bait tube (dashed lines) inside the small diameter bristle worm trap chamber and passage and a bait tube plug inserted in each end of the bait tube securing it within the small diameter bristle worm trap chamber and passage and sealing the two passageway openings, and further showing the drilled worm tunnels leading from the outside of the live rock to the bristle worm trap bait tube to enable the bristle worms to enter the bristle worm trap bait tube.

### DETAILED DESCRIPTION OF THE INVENTION

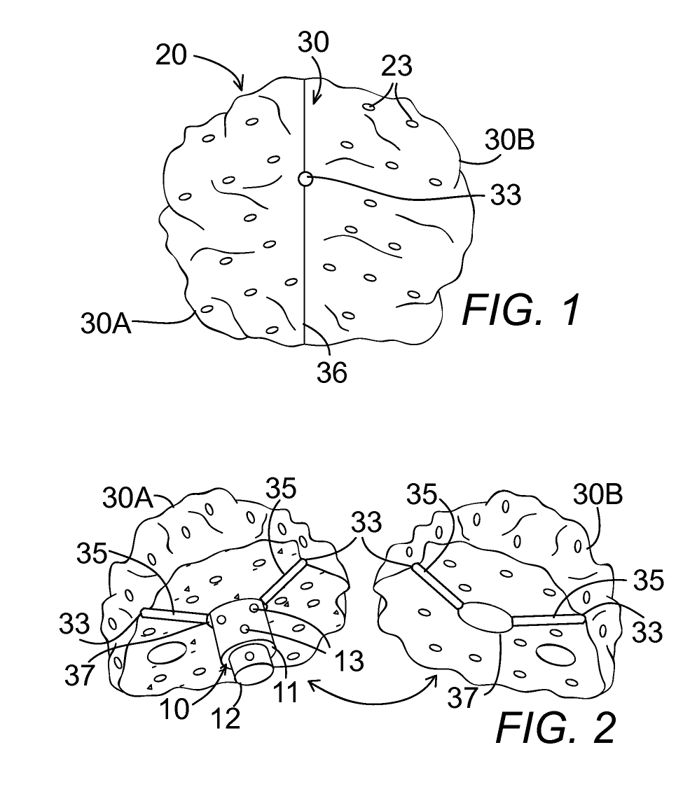

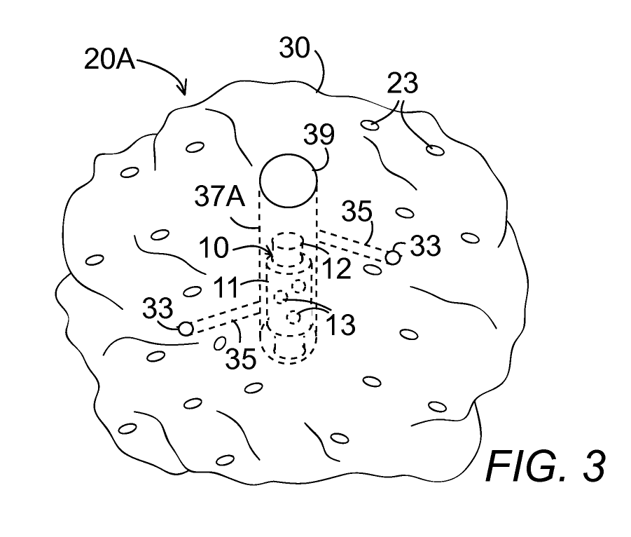

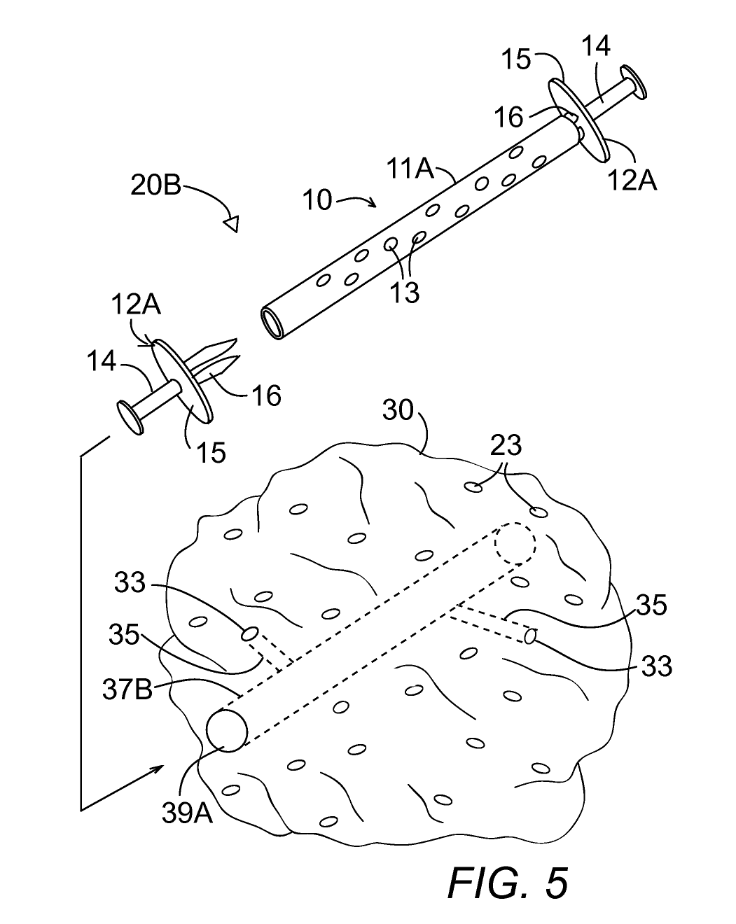

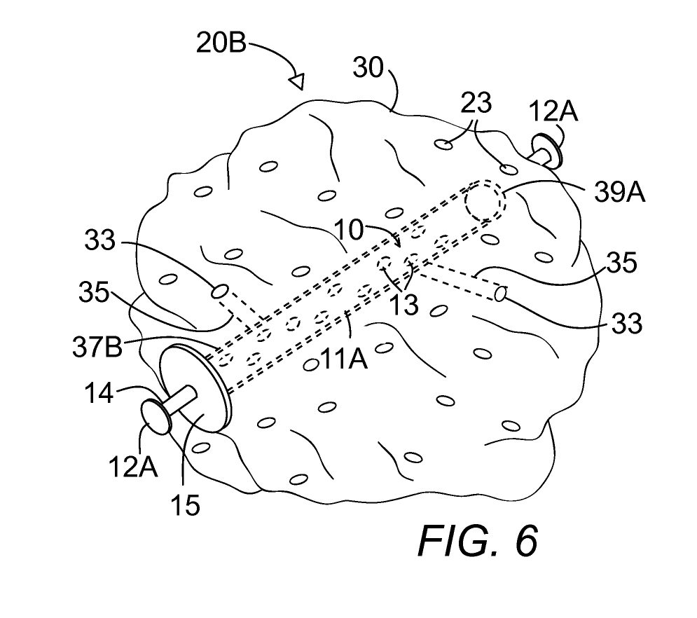

In FIGS. 1-6, a bristle worm trapping device 20, 20A and 20B for salt water aquariums 40 comprises either a split stone embodiment of the bristle worm trapping device 20 of FIGS. 1, 2, and 4 or a first alternate embodiment with a drilled interior bristle trap chamber 37A in the bristle worm trapping device 20A of FIG. 3 or a second alternate embodiment with a drilled interior bristle trap chamber 37B completely through the bristle worm trapping device 20B of FIGS. 5 and 6.

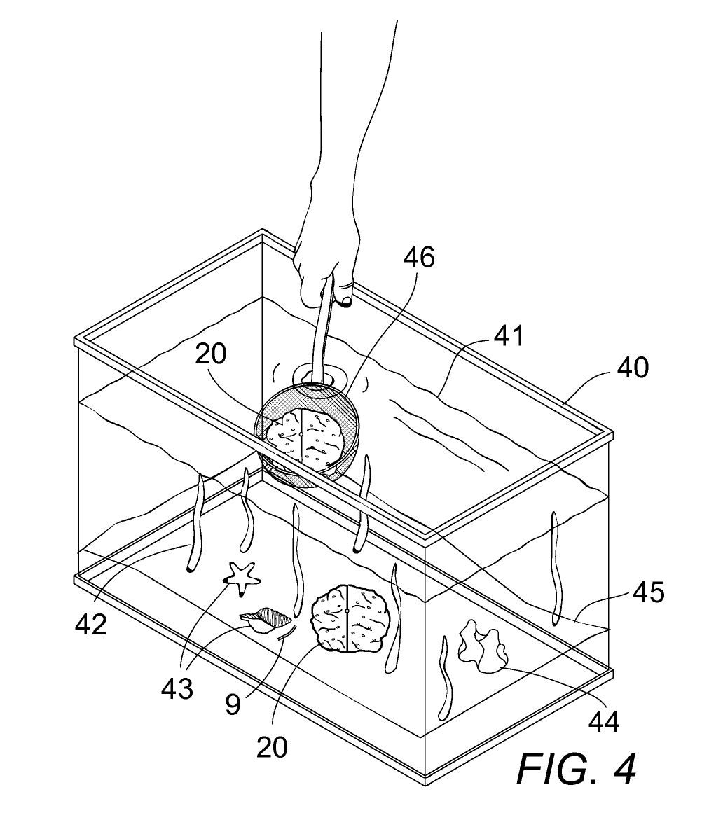

The bristle worm trapping device in the form of a live rock or rock 20, 20A, and 20B, which may be a live rock 30, forming a Bristle Stone™ trap simulating a bristle worm's natural home to attract bristle worms 9, as shown in FIG. 4. The Bristle Stone™ trap 20, 20A, and 20B comprises a live rock 30 having at least one interior bristle worm trap chamber 37, 37A and 37B and at least one chamber access tunnel 35 formed in the live rock 30, extending between the interior bristle worm trap chamber 37, 37A and 37B and at least one exterior opening 33 to admit bristle worms to pass through the exterior opening 33 and the chamber access tunnel 35 into the interior bristle worm trap chamber.

At least one removable bristle worm trap 10 is removably inserted in the at least one interior bristle worm trap chamber 37, 37A and 37B. The bristle worm trap 10 has at least one interior bait holding cavity, preferably the interior of a hollow tube 11, therein to contain bristle worm bait to attract the bristle worms 9 to enter the bristle worm trap. At least one bristle worm opening 13, and preferably a plurality of bristle worm openings 13, in the bristle worm trap 10 allows the bristle worms 9 to enter into the at least one bait holding cavity 11 to feed on the bristle worm bait. The bristle worm bait placed inside the bristle worm trap and the bristle worm trap 10 placed in the live rock 30 prior to placement of the Bristle Stone™ trap in a salt water aquarium 40 attracts bristle worms 9 into the bristle worm trap and they remain in the living rock to trap the bristle worms in the living rock. The bristle worm trap 10 is removable form the Bristle Stone™ trap 20, 20A, and 20B with the trapped bristle worms inside after removing the Bristle Stone™ trap from the salt water aquarium 40.

The bristle worm trap 10 comprises a removable bait holding tube 11 inserted in the interior bristle worm trap chamber 37, 37A, and 37B, the bait holding tube 11 comprising a hollow cylinder for holding the bristle worm bait, at least one end cap 12 or 12A at an end of the hollow cylinder for installing and retaining the bristle worm bait therein, the bait holding tube 13 having a plurality of spaced bristle worm openings 13 along the length of the bristle worm trap 10 for admitting the bristle worms therethrough to feed on the bristle worm bait. The bait holding tube 11 may be fabricated from a section of plastic pipe, or a section of plastic tubing, which may be clear, and preferably comprises an end cap 12 or 12A on each end of the section of plastic pipe. After

In FIGS. 1 and 2, the bristle rock trap 20 comprises a split 36 in the live rock 30 formed by cutting the live rock into at least two live rock pieces 30A and 30B so that the pieces are separable to provide the means for accessing the at interior bristle worm trap chamber 37 to load the bristle worm bait into the bristle worm trap 10 and to remove trapped bristle worms from the bristle worm trap.

The interior bristle worm trap chamber 37 comprises a mating cylindrical opening drilled into each of two separable mating pieces 30A and 30B of the live rock, the two mating cylindrical openings mating together to form the at least one interior bristle worm trap chamber 37 when the bristle worm bait is placed in the bristle worm trap 10 and the two mating pieces of the live rock are joined together in the shape of an original solid live rock to form the Bristle Stone™ trap 20.

In FIG. 3, in another embodiment, the interior bristle worm trap chamber 37A comprises a cylindrical opening 39 drilled from the exterior cavity opening of the rock 30 to the interior of the live rock. The cylindrical opening 39 is sufficiently large to allow the loading of the bait holding tube 10 in the live rock 30, and the removal of the bait holding tube 10 to remove the trapped bristle worms from the live rock thereby providing the means for accessing the at least one interior bristle worm trap chamber 37A to load the bristle worm bait into the bristle worm trap 10 and to remove trapped bristle worms from the bristle worm trap 10.

In FIG. 4, a mesh scoop 46 installs the bristle worm trap 20 in the sand 45 in the salt water aquarium 40 among the sea plants 42, coral 44 and other sea creatures 43 to attract bristle worms 9. The mesh scoop 46 also removes the device from the salt water 41 in the aquarium 40 to remove the bristle worms 9 in the device 20.

In FIGS. 5 and 6, an alternate embodiment of the Bristle Stone™ worm trapping device 20 has a narrow tunnel drilled through the stone from an opening 39A on one side to an opening on an opposite side to create a small diameter bristle worm trap chamber and access passageway or bristle worm bait trap tunnel 37B open at each end and showing the small diameter bait tube 11A which fits in the full length of the bristle worm bait trap tunnel 37B, as shown in FIG. 6, from one opening 39A to the other and a bait tube plug 12A at each end of the bait tube 11A, each bait tube plug having a pronged tip 16 for insertion into an end of the bait tube with a tight tension fit and an outer stone engaging ring 15 for retaining the bait tube within the live rock and sealing the end of the bristle worm bait trap tunnel 37B, an outwardly protruding grip 14 for inserting and removing the bait tube plug 12A, and a series of spaced worm openings 13 along the length of the bait tube to allow the bristle worms to enter the bait tube.

In FIG. 6, the bristle worm trap bait tube 11 (dashed lines) is inside the bristle worm bait trap tunnel 37B and a bait tube plug 12A is inserted in each end of the bait tube securing it within the bristle worm bait trap tunnel 37B and sealing the two tunnel openings. The drilled bait or chamber access tunnels 35 leading from the outside openings 33 of the live rock open into the bristle worm bait trap tunnel 37B to enable the bristle worms to enter the bait tube 11. An outwardly protruding grip 14 is used for gripping to insert and remove the bait tube plug 12A.

The Bristle Stone™ trap rock may be fabricated from a natural stone, which may be a live rock or fabricated of an artificial material to resemble a live rock fabricated from at least one material taken from the list of materials including a polyresin material, a resin material, a polystone material, an acrylic material, a plastic material, or other synthetic material which may be molded into the shape of a living rock.

In use, in FIGS. 1, 2, and 4, a bristle worm trapping method for salt water aquariums comprises

a first step of cutting a live rock 30 into at least two mating pieces 30A and 30B (as shown in FIG. 2) assembled together to form a Bristle Stone™ trap 20 to simulate a bristle worm's natural home to attract bristle worms;

a second step of drilling a mating cylindrical opening drilled into each of two mating pieces of the live rock, the two mating cylindrical openings mating together to form at least one interior bristle worm trap chamber 37 when the at least two pieces of live rock are joined together to contain a bristle worm trap 10 in the interior bristle worm trap chamber 37 to attract the bristle worms 9 to enter the bristle worm trap;

a third step of drilling at least one chamber access tunnel 35 in the live rock extending between the at least one interior bristle trap chamber 37 and at least one exterior opening 33 to admit bristle worms to pass through the at least one exterior opening and the at least one chamber access tunnel into the at least one interior bristle worm trap chamber 37;

a fourth step of loading in at least one removable bristle worm trap 10 removably inserted in the interior bristle worm trap chamber 37, the at least one bristle worm trap having at least one interior bait holding cavity formed therein to contain bristle worm bait to attract the bristle worms to enter the at least one removable bristle worm trap, and at least one bristle worm opening 13 in the at least one bristle worm trap to allow the bristle worms to enter into the at least one bait holding cavity to feed on the bristle worm bait, the at least one bristle worm opening sized to admit a hungry bristle worm 9 to enter the at least one bristle worm bait trap 10 to feed. Bristle worm bait is placed inside the bristle worm trap and the bristle worm trap placed in the live rock prior to placement of the Bristle Stone™ trap in a salt water aquarium 40 attracts bristle worms into the bristle worm trap to trap the bristle worms after feeding so that the bristle worm trap is removable form the Bristle Stone™ trap with the trapped bristle worms inside after removing the Bristle Stone™ trap with the at least two pieces of live rock separated and joining the at least two mating pieces of the live rock together in the shape of an original live rock to form the Bristle Stone™ trap;

a fifth step of placing the Bristle Stone™ trap 20 in a salt water aquarium 40 to trap the bristle worms; and

a sixth step of removing the Bristle Stone™ trap from the salt water aquarium and separating the at least two pieces of live rock 30A and 30B to remove the trapped bristle worms from the at least one interior bait holding cavity.

In FIG. 3, an alternate bristle worm trapping method for salt water aquariums comprises:

a first step of drilling at least one cylindrical opening 39 from the exterior of a live rock 30 to the interior of the live rock, the at least one cylindrical opening sufficiently large so that it comprises in combination an interior bristle worm trap chamber 37A and a means for accessing the interior bristle worm trap chamber to contain a bristle worm trap therein to form a Bristle Stone™ trap 20A to simulate a bristle worm's natural home to attract bristle worms;

a second step of drilling at least one chamber access tunnel 35 in the live rock extending between the at least one interior bristle worm trap chamber 37A and at least one exterior opening 33 to admit bristle worms 9 to pass through the at least one exterior opening 33 and the at least one chamber access tunnel 35 into the at least one interior bristle worm trap chamber 37A;

a third step of loading in at least one removable bristle worm trap 10 removably inserted in the at least one interior bristle worm trap chamber, the at least one bristle worm trap having at least one interior bait holding cavity formed therein to contain bristle worm bait to attract the bristle worms to enter the at least one removable bristle worm trap, and at least one bristle worm opening 13 in the at least one bristle worm trap to allow the bristle worms to enter into the at least one bait holding cavity to feed on the bristle worm bait, so that bristle worm bait placed inside the bristle worm trap and the bristle worm trap placed in the live rock prior to placement of the live rock trap attracts bristle worms into the bristle worm trap to trap the bristle worms after feeding so that the bristle worm trap is removable form the Bristle Stone™ trap with the trapped bristle worms inside after removing the Bristle Stone™ trap;

a fourth step of placing the Bristle Stone™ trap in a salt water aquarium 40 (as shown in FIG. 4) to trap the bristle worms; and

a fifth step of removing the Bristle Stone™ trap 20A from the salt water aquarium;

a sixth step of removing the bristle worm trap 10 from the Bristle Stone™ trap 20A and removing the trapped bristle worms from the at least one interior bait holding cavity in the at least one bristle worm trap.

In FIGS. 5 and 6, another alternate bristle worm trapping method for salt water aquariums comprises:

a first step of drilling at least one bristle worm bait trap tunnel opening 39A and bristle trap chamber tunnel 37B drilled completely through the live rock from an opening 39A on one side to an opening 39A on an opposite side to form a combined bristle worm trap chamber and means for accessing the bristle worm trap and form a Bristle Stone™ trap 20B to simulate a bristle worm's natural home to attract bristle worms;

a second step of drilling at least one chamber access tunnel 35 in the live rock extending between the at least one interior bristle worm trap chamber 37B and at least one exterior opening 33 to admit bristle worms to pass through the at least one exterior opening 33 and the at least one chamber access tunnel 35 into the at least one interior bristle worm trap chamber;

a third step of inserting a bristle worm trap 10 comprising a removable bait holding tube 11A removably inserted in the bristle worm bait trap tunnel 37B, the removable bait holding tube extending from the opening 39A on the one side to the opening 39A on the opposite side, the removable bait holding tube having spaced worm openings 13 along the length of the bait holding tube to allow the bristle worms to enter the bait holding tube to feed on the bristle worm bait, and further comprising inserting a bait tube plug 12A at each end of the bait holding tube 11A, each bait tube plug 12A having a pronged tip 16 for insertion into an end of the bait holding tube with a tight tension fit and an outer plug ring 15 for engaging an outer live rock surface around the opening 39A for retaining the bait holding tube within the live rock and sealing the end of the bait holding tube so that bristle worm bait placed inside the bristle worm trap 10 and the bristle worm trap placed in the live rock 30 prior to placement of the Bristle Stone™ trap in a salt water aquarium 40 to attract bristle worms 9 into the bristle worm trap to trap the bristle worms after feeding so that the bristle worm trap is removable form the Bristle Stone™ trap with the trapped bristle worms inside after removing the Bristle Stone™ trap;

a fourth step of placing the Bristle Stone™ trap 20B in a salt water aquarium 40 to trap the bristle worms; and

a fifth step of removing the bristle stop trap 20B from the salt water aquarium;

a sixth step of removing the at least one bristle worm trap 10 from the Bristle Stone™ trap and removing the trapped bristle worms from the at least one interior bait holding cavity in the at least one bristle worm trap.

It is understood that the preceding description is given merely by way of illustration and not in limitation of the invention and that various modifications may be made thereto without departing from the spirit of the invention as claimed.

What is claimed is:

1. A bristle worm trapping device for salt water aquariums, the device comprising:
a bristle worm trap simulating a bristle worm's natural home to attract bristle worms, the bristle worm trap comprising a live rock having at least one interior bristle worm trap chamber and at least one chamber access tunnel formed in the live rock extending between the interior bristle worm trap chamber and at least one exterior opening to admit bristle worms to pass through the exterior opening and the chamber access tunnel into the interior bristle worm trap chamber, and means for accessing the at least one bristle worm chamber to install therein and remove therefrom at least one bristle worm trap;
at least one removable bristle worm trap removably inserted in the at least one interior bristle worm trap chamber, the at least one bristle worm trap having at least one interior bait holding cavity formed therein to contain bristle worm bait to attract the bristle worms to enter the at least one removable bristle worm trap, and at least one bristle worm opening in the at least one bristle worm trap to allow the bristle worms to enter into the at least one bait holding cavity to feed on the bristle worm bait, the at least one bristle worm opening sized to admit a hungry bristle worm to enter the at least one bristle worm bait trap to feed, so that bristle worm bait placed inside the bristle worm trap and the bristle worm trap placed in the live rock prior to placement of the bristle worm trap in a salt water aquarium attracts bristle worms into the bristle worm trap to trap the bristle worms after feeding so that the bristle worm trap is removable form the bristle worm trap with the trapped bristle worms inside after removing the bristle worm trap from the salt water aquarium.

2. The device of claim 1 wherein the bristle worm trap is fabricated from an artificial material to resemble a live stone.

3. The device of claim 2 wherein the bristle worm trap is fabricated from at least one material taken from the list of materials including a polyresin material, a resin material, a polystone material, an acrylic material, and a plastic material.

4. The device of claim 1 wherein the at least one bristle worm trap comprises a removable bait holding tube inserted in the at least one interior bristle worm trap chamber, the bait holding tube comprising a hollow cylinder for holding the bristle worm bait, at least one end cap at an end of the hollow cylinder for installing and retaining the bristle worm bait therein and for removing the well fed bristles worms therefrom, and a plurality of spaced bristle worm openings along the length of the at least one bristle worm trap for admitting the bristle worms therethrough to feed on the bristle worm bait.

5. The device of claim 4 wherein the bait holding tube hollow cylinder comprises a section of plastic pipe and further comprising an end cap on each end of the section of plastic pipe.

6. The device of claim 4 wherein the bait holding tube hollow cylinder comprises a section of plastic tubing and further comprising an end cap on each end of the section of the plastic tubing.

7. The device of claim 1 wherein the means for accessing the at least one interior bristle worm trap chamber to load the bristle worm bait into the at least one bristle worm trap and to remove trapped bristle worms from the at least one bristle worm trap comprises a split formed in the live rock to form at least two separable mating pieces of the live rock for separating the live rock into at least two pieces to openly access the at least one interior bristle worm trap chamber.

8. The device of claim 7 wherein the at least one interior bristle worm trap chamber comprises a mating cylindrical opening drilled into each of two separable mating pieces of the live rock, the two mating cylindrical openings mating together to form the at least one interior bristle worm trap chamber when the bristle worm bait is placed in the bristle worm trap and the two mating pieces of the live rock are joined together in the shape of an original solid live rock to form the bristle worm trap.

9. The device of claim 1 wherein the means for accessing the at least one interior bristle worm trap chamber to load the bristle worm bait into the at least one bristle worm trap and to remove trapped bristle worms from the at least one bristle worm trap comprises a cylindrical opening drilled from the exterior of the live rock to the interior of the live rock, the cylindrical opening sufficiently large so that it comprises in combination the interior bait holding cavity and the means for accessing the at least one bristle worm trap.

10. The device of claim 1 wherein the means for accessing the at least one interior bristle worm trap chamber to load the bristle worm bait into the at least one bristle worm trap and to remove trapped bristle worms from the at least one bristle worm trap comprises a bristle worm bait trap tunnel drilled completely through the live rock from an opening on one side to an opening on an opposite side to form a combined bristle worm trap chamber and means for accessing the bristle worm trap.

11. The device of claim 10 wherein the bristle worm trap comprises a removable bait holding tube removably inserted in the bristle worm bait trap tunnel, the removable bait holding tube extending from the opening on the one side to the opening on the opposite side, the removable bait holding tube having spaced worm openings along the length of the bait holding tube to allow the bristle worms to enter the bait holding tube to feed on the bristle worm bait, and further comprising a bait tube plug at each end of the bait holding tube, each bait tube plug having a pronged tip for insertion into an end of the bait holding tube with a tight tension fit and an outer plug ring for engaging an outer live rock surface around the opening for retaining the bait holding tube within the live rock and sealing the end of the bait holding tube, an outwardly protruding grip for gripping to insert and remove the bait tube plug.

12. The device of claim 1 wherein the plurality of openings communicating with the at least one interior bristle worm trap chamber for admitting bristle worms into the bristle worm trap chamber comprise a plurality of bait access tunnels drilled into the live rock between the interior bristle trap chamber and the exterior of the live rock.

13. A bristle worm trapping method for salt water aquariums, the method comprising:
a first step of cutting a live rock into at least two mating pieces assembled together to form a bristle worm trap to simulate a bristle worm's natural home to attract bristle worms;
a second step of drilling a mating cylindrical opening drilled into each of two mating pieces of the live rock, the two mating cylindrical openings mating together to form at least one interior bristle worm trap chamber when the at least two pieces of live rock are joined together to contain a bristle worm trap in the interior bristle worm trap chamber to attract the bristle worms to enter the bristle worm trap;
a third step of drilling at least one chamber access tunnel formed in the live rock extending between the interior bristle worm trap chamber and at least one exterior opening to admit bristle worms to pass through the exterior opening and the chamber access tunnel into the interior bristle worm trap chamber;
a fourth step of loading in at least one removable bristle worm trap removably inserted in the at least one interior bristle worm trap chamber, the at least one bristle worm trap having at least one interior bait holding cavity formed therein to contain bristle worm bait to attract the bristle worms to enter the at least one removable bristle worm trap, and at least one bristle worm opening in the at least one bristle worm trap to allow the bristle worms to enter into the at least one bait holding cavity to feed on the bristle worm bait, the at least one bristle worm remaining in the live rock after feeding thereby trapping the at least one bristle worm inside the at least one bristle worm trap, so that bristle worm bait placed inside the bristle worm trap and the bristle worm trap placed in the live rock prior to placement of the bristle worm trap in a salt water aquarium attracts bristle worms into the bristle worm trap to trap the bristle worms after feeding so that the bristle worm trap is removable form the bristle worm trap with the trapped bristle worms inside after removing the bristle worm trap with the at least two pieces of live rock separated and joining the at least two mating pieces of the live rock together in the shape of an original live rock to form the bristle worm trap;
a fifth step of placing the bristle worm trap in a salt water aquarium to trap the bristle worms; and
a sixth step of removing the bristle worm trap from the salt water aquarium and separating the at least two pieces of live rock to remove the trapped bristle worms from the at least one interior bait holding cavity.

14. A bristle worm trapping method for salt water aquariums, the method comprising:
a first step of drilling at least one cylindrical opening from the exterior of a live rock to the interior of the live rock, the at least one cylindrical opening sufficiently large so that it comprises in combination an interior bristle worm trap chamber and a means for accessing the interior bristle worm trap chamber to contain a bristle worm trap therein to form a bristle worm trap to simulate a bristle worm's natural home to attract bristle worms;
a second step of drilling at least one chamber access tunnel in the live rock extending between the at least one interior bristle worm trap chamber and at least one exterior opening to admit bristle worms to pass through the at least one exterior opening and the at least one chamber access tunnel into the at least one interior bristle worm trap chamber;
a third step of loading in at least one removable bristle worm trap removably inserted in the at least one interior bristle worm trap chamber, the at least one bristle worm trap having at least one interior bait holding cavity formed therein to contain bristle worm bait to attract the bristle worms to enter the at least one removable bristle worm trap, and at least one bristle worm opening in the at least one bristle worm trap to allow the bristle worms to enter into the at least one bait holding cavity to feed on the bristle worm bait, the at least one bristle worm remaining in the live rock thereby trapping the at least one bristle worm inside the at least one bristle worm trap, so that bristle worm bait placed inside the bristle worm trap and the bristle worm trap placed in the live rock prior to placement of the bristle worm trap attracts bristle worms into the bristle worm trap to trap the bristle worms after feeding so that the bristle worm trap is removable form the bristle worm trap with the trapped bristle worms inside after removing the bristle worm trap;
a fourth step of placing the bristle worm trap in a salt water aquarium to trap the bristle worms; and
a fifth step of removing the bristle stop trap from the salt water aquarium;
a sixth step of removing the at least one bristle worm trap from the bristle worm trap and removing the trapped bristle worms from the live rock.

15. The method of claim 14 wherein the first step comprises drilling a bristle worm bait trap tunnel drilled completely through the live rock from an opening on one side to an opening on an opposite side to form a combined bristle worm trap chamber and means for accessing the bristle worm trap.

16. The method of claim 14 wherein the third step comprises inserting a bristle worm trap comprising a removable bait holding tube removably inserted in the bristle worm bait trap tunnel, the removable bait holding tube extending from the opening on the one side to the opening on the opposite side, the removable bait holding tube having spaced worm openings along the length of the bait holding tube to allow the bristle worms to enter the bait holding tube to feed on the bristle worm bait, and further comprising inserting a bait tube plug at each end of the bait holding tube, each bait tube plug having a pronged tip for insertion into an end of the bait holding tube with a tight tension fit and an outer plug ring for engaging an outer live rock surface around the opening for retaining the bait holding tube within the live rock and sealing the end of the bait holding tube.
